(19) United States
(12) Patent Application Publication
(10) Pub. No.: US 2014/0012831 A1
(43) Pub. Date: Jan. 9, 2014

(54) TILE CONTENT-BASED IMAGE SEARCH

(71) Applicants: David Whitney Wallen, Windsor, CA (US); Richard Cary Dice, San Francisco, CA (US)

(72) Inventors: David Whitney Wallen, Windsor, CA (US); Richard Cary Dice, San Francisco, CA (US)

(21) Appl. No.: 13/936,133

(22) Filed: Jul. 5, 2013

Related U.S. Application Data
(60) Provisional application No. 61/669,060, filed on Jul. 7, 2012.

(51) Int. Cl. G06F 17/30

(52) U.S. Cl. CPC G06F 17/30268; G06F 17/30867
USPC 707/709; 707/743

(57) ABSTRACT

Images are processed by extracting a number of small, fixed size pixel arrays, here called tiles. The image is thus represented as a collection of small parts in almost cookie cutter fashion. For storage, the tile data are added to a database and indexed for fast recall. Stored images can be rescaled, possibly rotated, and inserted again for more robustness. A sample image for recall is likewise processed, the extracted tiles serving as keys to find their stored counterparts. The original image can thus be recognized from even a small portion of the original image, if the sample offers enough tiles for lookup. The invention includes an image collection module, an image processing module, a storage module, a recall module and an interactive module by which a user can query a sample image or sub-image against the stored information.

### BACKGROUND OF THE INVENTION

Content based image recall has a broad scope. Examples of associative memory arrays using neural network models can retrieve the full image based on a partial sample image, but their capacity, the number of images learned, is relatively low. Feature-based systems typically generate a set of feature vectors from the image. The vectors are categorized statistically and stored and can be recalled based on similarities to the feature vectors likewise generated from a sample image. However, vectors generated from a partial image may not offer a close match to the original stored vectors. Important features may be absent from the partial image sample presented for recall, leading to an unwanted recall. What is missing is the ability to identify the original image from one or more small sections of arbitrary shape and location, taken from the that image. This facility is useful to anyone looking for the original source of a clipped, or masked and/or rescaled image. In the realm of text-based searching this is akin to a document search using one or more quoted pieces of text.

### SUMMARY OF THE INVENTION

The present invention provides for large scale content-based image indexing and search at high speed and low cost. At minimum, the system consists of a collection of images to be processed, an image processing module which processes an image, a storage module (database) which holds the processed results with the image source information, and a recall module which searches the database for image candidates matching a sample image. A more advanced implementation also includes a web crawler which crawls the internet, discovering and loading images and adding their processed results to the database. In addition, the web-based version has a means for users to upload sample images and perform searches. Finally, a robotics module might include a camera input to store scene images, or recall information from such an image. Each module above might consist of multiple commodity machines, or the entire set of modules can run on a single PC.

For example, a current version of the system includes multiple crawlers, running on five separate PCs, gathering and processing image data held in a MySQL database, distributed across six PCs, currently holding indexed data from approximately 3.6 million images. A standalone version running on a modest laptop can scan around fifteen thousand disk-based image files in two hours, including resizing and reprocessing each image multiple times for full scale coverage. Image recall from partial samples takes a few seconds. Recall speed depends on how much of the database fits in machine memory. The system is heavily dependent on database technology, and easily scales out to more machines.

The storage process is roughly akin to extracting a set of cookie cutter pieces (here called tiles) from the image and storing them in the database with an image identifier (an image id). Recognition is the reverse process, and the pieces are extracted from the sample. These sample pieces, if found in database, yield the image identifiers of all the images known to contain them. From this set of candidate images, the best match is selected as the candidate image with the most pieces whose original locations are consistent with their counterparts in sample image.

More specifically, the method of image processing employed first extracts, from each image, tiny pixel arrays, here called tiles. Unlike cookies, the tiles are allowed to overlap. The tiles are quantized with some attributes and stored with the image identifier for later recall. This is done for each image at successively reduced sizes, and if desired, at multiple rotations. Tile size is small and fixed for example, 8 by 8 pixels.

Image recall from a sample consists in applying a similar tile extraction procedure to the sample image, and searching the database for each extracted tile. Every individual tile query returns a list of images known to contain that tile. The full list of retrieved candidate images is then refined to select the best matching images. Recall is possible using all of the original, or only a subset of the original image, including a small cut out, or a masked original. If no good match is found, the sample image can be rescaled slightly, or rotated slightly until and the recall process repeated, until either a match is found or it is clear that there is no matching image in the database.

### DESCRIPTION OF THE DRAWINGS

FIG. 1 is a flow diagram showing how an image is added to the database, from file, from camera input, or from a file on the web;

FIG. 2 is a flow diagram showing how a sample image is searched for;

FIG. 3 shows a typical image, with the grid imposed on it, each grid element offering up to one tile whose upper left corner lies somewhere within that grid element;

FIG. 4 is a detail view of 9 grid elements, each with a tile selected, showing that selected tiles can overlap;

FIG. 5 is a detail of the upper left corner grid element of FIG. 4, showing the numeric weights of each tile, with the weights typically based on tile variance;

FIG. 6 shows a database input row corresponding to one tile being stored;

FIG. 7 shows database query select data, for requesting all matching stored tiles;

FIG. 8 is the weighted image from FIG. 3 with lighter areas indicating greater variance;

FIG. 9 displays the binary tiles extracted from the image of FIG. 3;

FIG. 10 shows a sample image for recall.

FIG. 11 shows the tiles extracted, as an image;

FIG. 12 shows how Image number 1002 correctly matches all the tiles;

FIG. 13 shows other images which each match only a few tiles, in the wrong places.

### DETAILED DESCRIPTION OF THE INVENTION

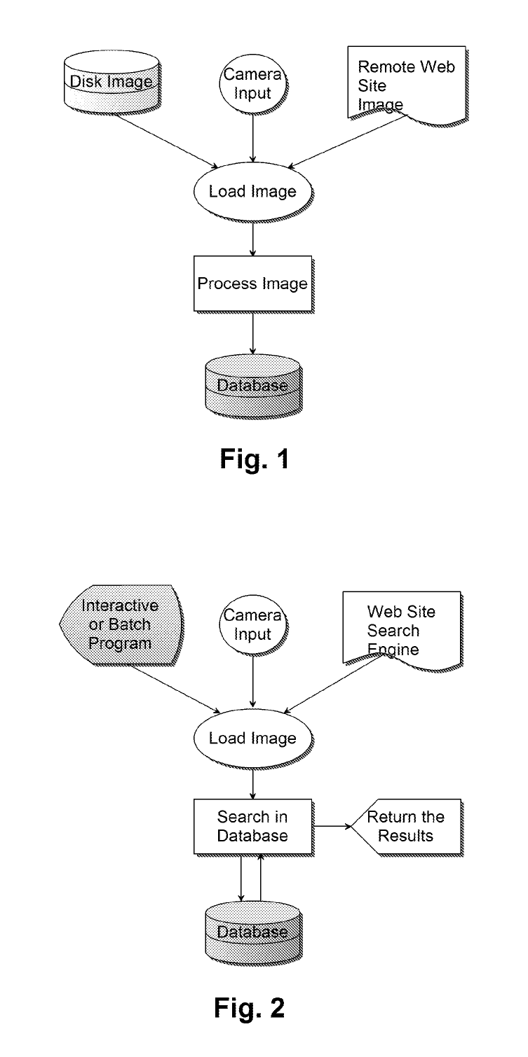

Web crawlers, database systems, and AJAX-enabled web search forms are fairly generic and won't be described in great detail here beyond the idea that the web crawler discovers images on the web, which are later retrieved and processed and the results stored in the database for later recall. The web search facility includes a way for users to upload a portion of a possibly rescaled image, which is submitted to the search module, and the results are returned via a web form. FIG. 1. and FIG. 2. show the path of an image from disk file, from camera, or from a file on the web. Processing is similar whether for inserting or for recall.

To store an image, the image processing module works as follows. A large collection of small fixed-size bitmaps, here called tiles, is extracted from the image, a tile being a small image of preset fixed size, for example, 8×8 pixels. A representation of each tile's contents, its coordinates and its source image id is stored in the database. In this way, images are decomposed into tiles which are stored in the database. Image recall is similar.

With recall, sample image identification consists in extracting a set of tiles from the sample image and searching for corresponding tiles in the database. Matching tiles are retrieved from the database, along with their source image id reference and source image coordinates. The source image with the most recalled tiles is a good match candidate. Moreover, the most likely candidate image is the one whose retrieved tiles' coordinates match most consistently with their corresponding sample tile's coordinates.

An abundance of matching tiles and consistent coordinates for a specific stored image strongly indicates that stored image as the best matching candidate. Candidate images are ranked accordingly, and the results returned as a sorted list of most likely source images. Additionally, each candidate image from the results list can be directly compared with the sample image to further refine the results.

If there is no satisfactory candidate, perhaps the sample is at a different scale from the corresponding original. The sample can be rescaled slightly and the search process repeated. To speed up searching, original images can be processed and stored at a number of scales, starting at 100%, 75%, 50%, 25% magnification, and so on, down to an minimum absolute size. If desired, any number of image rotations can also be processed and stored likewise. Storing all these other versions of an image allows for faster recall, since fewer rescale operations on the sample will be needed during search before a scale is reached that corresponds to one of those scales stored, triggering a recall. The tradeoff is fast recall speed versus greater cost for the increased storage capacity required to hold data from the rescaled and/or rotated copies of the original.

What follows are specific details of an embodiment of the invention. In our implementation, pixel intensity (gray scale) values are used, so an image is first converted to gray scale before processing. We also extract and save the tile's average color. Alternatively, the same procedures described here can be applied to color separated images, for even greater recall power. That is, the red, green and blue (or C,M,Y) intensity images could be processed separately in the same fashion described here. In that case, tile color would be redundant, already represented in the separated components.

In this embodiment, to conserve computer resources, an image to be indexed is first rescaled so that its dimensions do not exceed 512 pixels in width and in height. The image is then processed as described below, and the procedure repeated at 50%, 25%, 12.5% scale, and so on while the rescaled dimensions exceed 32 pixels. The image could be rotated numerous times at each scale level as well, but our example doesn't do that, since rotated images aren't expected. Furthermore, images could be rotated prior to recall instead, providing that facility with a compromise in recall performance.

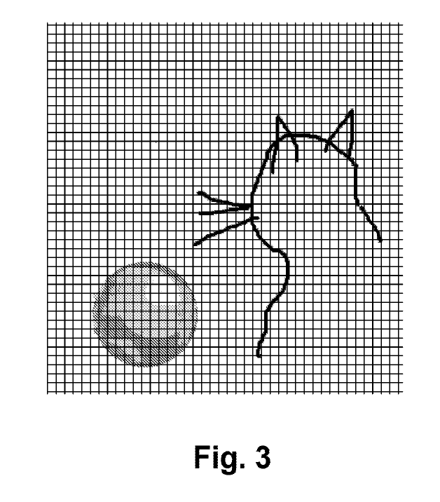

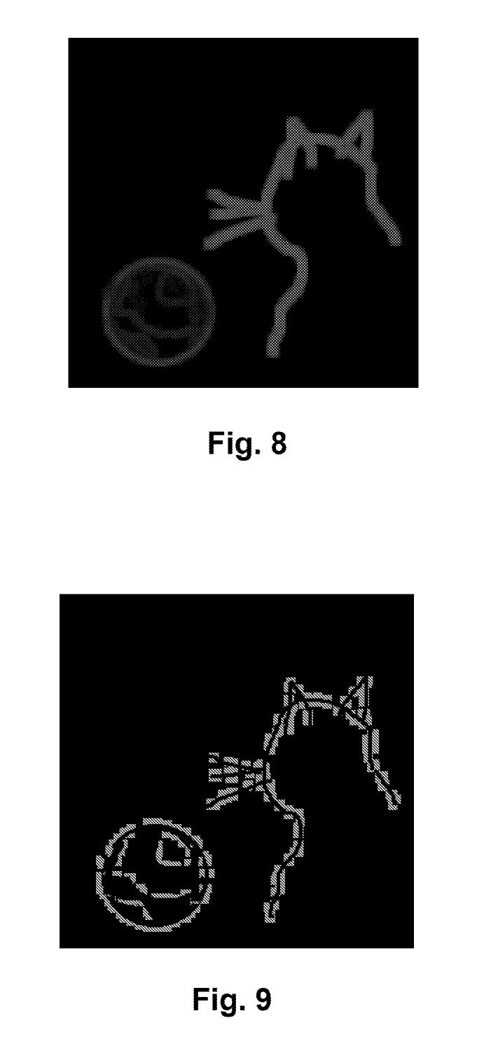

FIG. 3. shows an image with a grid imposed on it. The grid used in our example embodiment consists of 8×8 pixel regions, the same size as our tiles. From each grid element, a single tile is selected from the 64 such whose upper left coordinates lie within that grid element. The tile having the greatest gray scale variance, and (in case of ties) with the uppermost, leftmost origin is selected. Tiles selected from neighboring grid elements can overlap considerably, tracking areas of concentrated higher variance. High variance of the tile's pixel intensity indicates more information content, and is therefore favored. Other measures besides variance can be used, such as entropy or spatial moments information. FIG. 8 indicates the tile variance at every tile location. Brighter areas indicate higher variance. If none of the tiles originating within a grid element exceed a preset minimum variance, then no tile is selected from that grid element. The darker areas of FIG. 8 will not contribute tiles, as can be seen in FIG. 9.

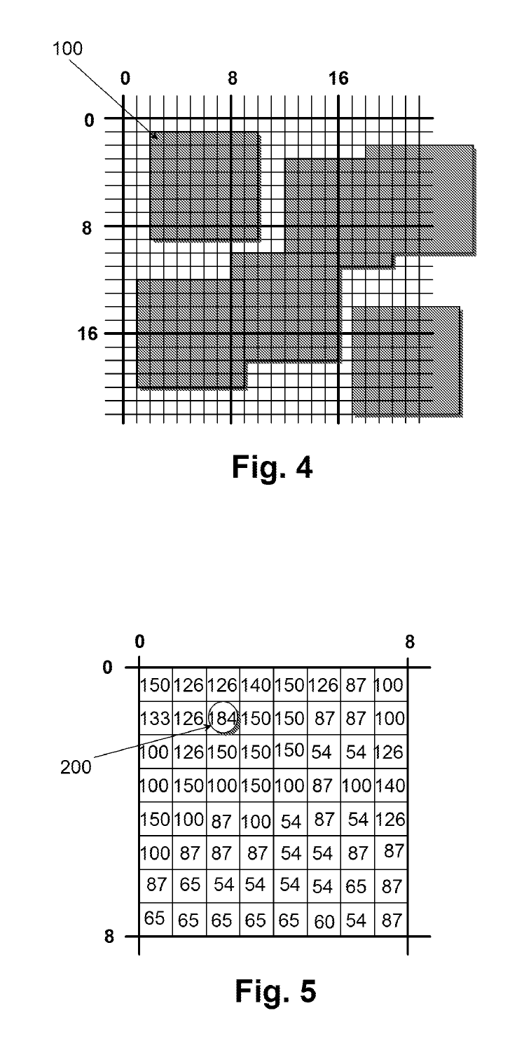

FIG. 4. shows tiles selected at offset (2,1) (label 100), and other tiles selected at (12,3), (18,2) and so on. FIG. 5 shows a detail of the upper leftmost grid element, with each number reflecting the variance of its corresponding 8×8 gray scale tile. The tile whose offset is (2,1) has the largest weight, 184 (label 200). The weight actually represents the standard deviation (square root of the variance) multiplied by a constant.

In the present example embodiment, each selected tile is converted to a binary value by applying a threshold equal to the tile's mean intensity value to each of the tile's pixels. The mean can be calculated far more quickly than the median, although the median could be used instead. Tile mean is a local image quality that automatically adjusts to changes in brightness across the image, providing a suitable threshold for every tile. Additionally, this threshold is immune to overall brightness changes in the sample image for recall, since pixels brighten or darken in tandem with the mean, staying above or below it.

The binary representation of the tile only requires 64 bits. This scheme was chosen to facilitate rapid search in a database. Although information is lost due to the threshold operation, an exact match of the bits is far faster than a search for closely matching tiles, which would require many more database operations. However, it must be noted that the binary conversion relies on a sample image with little imposed noise, since noise can cause a pixel to shift to the other side of the threshold, resulting in a bit pattern mismatch with the original. Even so, for a large sample image, even with some noise, it is often still possible to match some minimal set of tiles, resulting in a recognition.

The present embodiment ignores the selected tile if its binary representation has too little variation. In particular, the number of zero bits is required to range between 16 and 48. Although this limit isn't strictly necessary, it prevents adding numerous duplicate rows having only a few ones or zeros. FIG. 9 shows the tiles as binary bits for all the tiles collected. Brightness indicates pixels which exceeded the threshold. Overall dark areas had too little variance to enable them to contribute tiles.

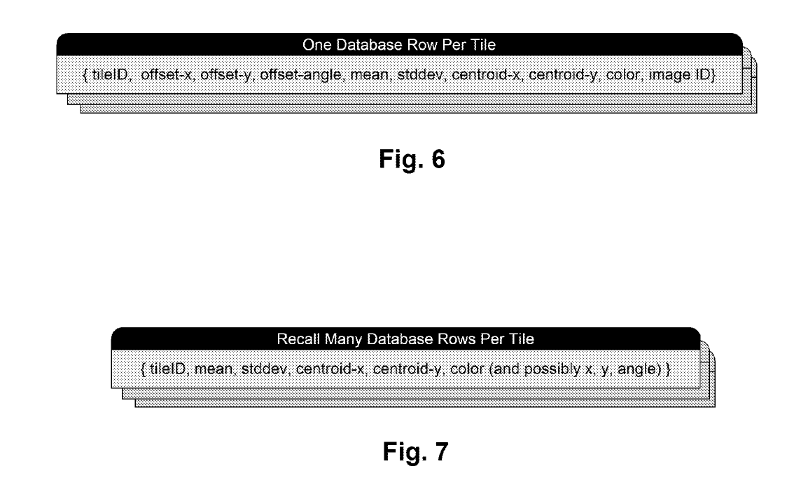

FIG. 6 shows all the data stored for a single tile, as a single row inserted into the database. The field named tileID is the tile's 64-bit value. As such, it isn't a unique identifier since there may be many occurrences of that bit pattern. Offset-x and offset-y are the tile's (x, y) coordinates from the image origin (upper left corner). Offset-angle is the polar coordinate angle from origin. Mean and stddev are the tile's pixel intensity mean and standard deviation. Centroid-x and Centroid-y are the tile's before-threshold centroid coordinates (range is 0.0 through 8.0 exclusive). Color is the original tile's average color, described in the next paragraph. This added information helps during recall to weed out dissimilar tiles which happen to have the same 64-bit binary value. Finally, the source image ID is kept with the tile as well, a link from the tile back to the original image.

The tile's average color is calculated as follows. An 8×8 mean filter (weights are all 1/64) is convolved with a copy of the original color image. The resulting blurred image is converted to a palette, using the nearest color from a simple (RGB) color cube. There are some 6 color levels each for red, green and blue, giving 216 index values, plus some 32 gray level index values, or 248 possible values. The color value for any tile is just the palette index for the color at corresponding blurred tile's origin.

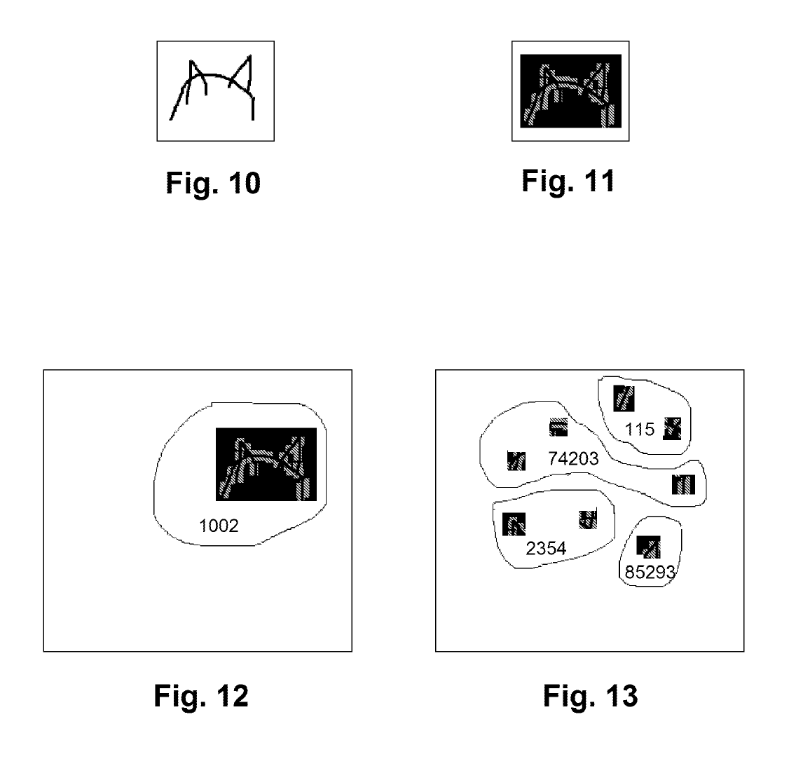

FIG. 10 shows a sample for recall taken from the image in FIG. 3. FIG. 11 shows the selected tile bit values. Image recall can have separate approaches. In general, the sample image can be a section cutout from the original, so the true offset of the sample is unknown. The process of gathering tiles needs to be a bit different from that used for parsing the original image, in order to ensure that among the tiles gathered from the sample, an adequate number of the original tiles are present. Otherwise, only if the sample grid happened to coincide with the original grid, would all the gathered tiles be identical to those gathered for the original image. Therefore, the program selects a set of tiles from across the sample image, ranks them by variance, and sends the top N to the the database as N separate queries. Care is taken to ensure that most of the sample area is represented, even if the tiles with greatest variance occur in limited areas of the sample.

For large sample images, a very large set of candidate tiles is possible. There are ways to reduce this set. One approach is to consider all 64 displacements for the grid origin, from (0,0) through (7,7), and use the regular input algorithm against each of these 64 displacements. Count the number of times each candidate tile is selected overall. This reflects its probability of selection in the original image, whose identity and origin are so far unknown. Rank the tiles thus, and select an evenly distributed set from across the sample image.

FIG. 7 shows the general information used by query to match tiles in the database. The tiles selected from the sample image are then passed to the database query stage. For each extracted tile, the query searches for the exact match of its 64-bit binary value, and a close match to its mean, stddev (standard deviation), centroid and color. The retrieved rows are sorted based on image ID. After all the chosen tiles from the sample image are likewise queried, there results a list of candidate images, each with a collection of corresponding tiles and their offsets.

Next, these candidate image tile collections are checked for their size and internal consistency. If many contained tiles have similar offset differences, that is, they all differ from the sampled location by a constant value, then they are consistent and the correct original image has likely been detected. If their coordinates differ from the sampled coordinates by random amounts, then that candidate image is an unlikely match, and gets a low ranking. FIG. 12 shows that the sample tiles align with image ID 1002, the matching image. FIG. 13 shows scattered tiles found in image IDs 115, 74203, 2354 and 85293. Their original tile coordinates are not consistent with their orientation in the sample image, so they don't match.

A further refinement when checking a collection of tiles serves as a hedge against sampling phase errors when the sample image is not the same size as any stored, scaled version. There are a number of ways to accommodate this. One is to reduce the sample image very slightly and repeat the search process. This can be time consuming. Another is to start with a highly reduced sample, and iterate by expanding slightly each iteration. This has the advantage that less processing is involved for smaller image size, and sample image noise tends to disappear with good quality image reduction, due to the averaging over large areas, performed during reduction. So, starting the search using a reduced copy of the sample image can lead to faster recall.

Yet another technique can work with an image whose tiles tend to be somewhat size invariant, like a vertical or horizontal edge. An edge looks the same at many scales. A collection of edge-tile offset differences can be fit to a linear model, which yields scale and offset in both dimensions (x and y). Outlier tiles can be removed in a repeated least-squares refinement process until a consistent set of matching tiles remains. These embody a good estimate of scale and shift from the sample to the stored image. The least-squares fitting process is elaborated in more detail in Steps 17 and 18 of the pseudo code listings for retrieving an image.

What follows are pseudo code listings for ADDING an image, and RETRIEVING an image from a sample.

### I. ADD Original Image with fileID Link to the ImageSources and Offsets Tables

(Image File Data Presumed Already Added to FileSources and PathSources Tables.)

1. If height or width exceeds 512 pixels, resize image maintaining aspect ratio.

2. If image height or width is less than 32 pixels, quit.

3. Add new Image record to ImageSources table, indicating current image size.

4. Generate a Grayscale Image from Original Image. For example, each RGB pixel is replaced by a gray pixel intensity, I, using a formula like: I=0.3*R+0.59*G+0.11*B.

5. Generate a Blurred Image by convolving Original image with 8×8 averaging filter.

6. Generate a Palettized Image from the Blurred Image using color cube.

(Palettized Image Pixels Hold Palette Index Number Representing Limited Color.)

7. Operate on Grayscale Image to generate a 8×8 Tile Variance Image, so each pixel represents corresponding tile's variance, as follows. Convolve Grayscale image with an 8×8 mean filter, and square each resulting pixel value, and call the image MeanSQ. Likewise, square each Grayscale Image pixel value, and convolve that result with an 8×8 mean filter, calling the result SquaredMean. Let Variance Image=SquaredMean−MeanSQ. In the Variance Image, each pixel represents corresponding 8×8 tile's variance.

8. Impose imaginary 8×8 pixel grid on Grayscale, Palettized and Variance Images.
For each 8×8 grid element:
9. Select the location with greatest value in Variance Image, refer to it as offsetX, offsetY.
10. Calculate offsetTheta as atan2 (offsetY, offsetX).
11. From Palettized Image, extract the color value at coordinates (offsetX, offsetY).
12. From Grayscale Image, extract the 8×8 tile whose upper left coordinates are (offsetX, offsetY).
13. Calculate the mean, stddev, centroidX, centroidY for the extracted tile.
14. Using the mean as a threshold value, generate a 64-bit binary value, tileID (not unique), from the tile values, one bit per pixel, as follows:

```
tileID = 0;
for (i=0; i<8; ++i)
    for (j=0; j<8; ++j)
    {
        if ( Grayscale(X+j,Y+i) > Mean(X,Y))
            tileID |= (1<<(j+(i*8)));
    }
```

15. INSERT INTO Offsets(tileID, imageID, offsetX, offsetY, offsetTheta, tileMean, tileSigma, centroidX, centroidY, colorIndex) VALUES (!, !, !, !, !, !, !, !, !, !).

16. Reduce Original Image size by 50 percent.

17. Go to step 2.

### II. RETRIEVE Best Match to Sample Image from Database

1. If height or width exceeds 512 pixels, rescale Sample Image maintaining aspect ratio.

2. If image height or width is less than 32 pixels, quit.

3. N/A.

4. Generate a Grayscale Image from Sample Image.

5. Generate a Blurred Image by convolving Sample image with 8×8 averaging filter.

6. Generate a Palettized Image from the Blurred Image using color cube.

(Palettized Image Pixels Hold Palette Index Number Representing Limited Color.)

7. Generate a Variance Image from the Grayscale Image.

8. Tiles =new collection ( );

for (Y=0; Y<Height−8; ++Y)

for (X=0; X<Width−8; ++X
{

if ( Variance(X,Y) > 20 ) // This is a good tile.
{

| | |
|---|---|
| 9. | colorIndex = PalettizedImage(X,Y); |
| 10. | From Grayscale Image, extract the 8×8 tile whose |
| | upper left coordinates are (X, Y). |
| 11. | Calculate the mean, stddev, centroidX, centroidY |
| | for the extracted tile. |
| 12. | Using the mean as a threshold value, generate the |
| | 64-bit tileID. |
| 13. | TileData = new Collection( ). |
| | TileData.addAll( tileID, X, Y, mean, stddev, |
| | centroidX, centroidY, colorIndex); |
| 14. | Tiles.Add( TileData ); |

}

}

15. For all the tiles collected in Steps 8-14, execute the following query with bound parameters.

```
SELECT imageId, offsetX, offsetY
FROM Offsets
WHERE( tileId = ?)
      and ((offsetX>=?) and (offsetY>=?)
            and (tileMean>=?) and (tileMean<=?)
            and (tileSigma>=?) and (tileSigma<=?)
            and (centroidX>=?) and (centroidX<=?)
            and (centroidY>=?) and (centroidY<=?)
            and (colorIndex=?)) LIMIT 100.
Parameters = ( tileID, X/2, Y/2, mean*0.9, mean*1.1,
            stddev*0.9, stddev*1.1,
            centroidX*0.9, centroidX*1.1,
            centroidY*0.9, centroidY*1.1, colorIndex );
```

16. For every tile query, collect the following record:

[ImageId, X, Y, offsetX, offsetY].

17. COMMENT: Consider a separate scatter plot for each ImageId, where deltaX=(X−offsetX) is plotted against deltaY=(Y−offsetY). From all the resulting scatter plots, one for each imageId, select the plot which has the largest cluster for some (detlaX, deltaY).

This suggests the best candidate image, and (deltaX, deltaY) is a good estimate for the upper left coordinate where to find the Sample Image embedded in the database's image at ImageId. This exercise can be done automatically using statistical functions. One way is described in the next step. However, there is a complication because if the Sample Image isn't at the same magnification, there will be a growth of deltaX with X, and deltaY with Y. The disparity between X and offsetX will stretch with distance from the origin. This tends to widen the scatter plot clusters, suggesting the approach taken below, a linear fit of X versus offsetX, and a separate linear fit of Y versus offsetY.

18. Group the returned records from Step 16 by ImageId. For each group, perform an iterative least squares fit of X versus offsetX, and a fit of Y versus offsetY, eliminating all (X, Y) pairs where either component, X or Y, has been discarded as an outlier. That is,

offsetX=X*scaleX+deltaX,

offsetY=Y*scaleY+deltaY.

The fit results in scaleX, deltaX, errorX, scaleY, deltaY, and errorY terms.

19. If the resulting fit is good, exit and return a ranked list of recognized imageId, scaleX, scaleY, offsetX,offsetY, errorX, errorY.

20. Otherwise, reduce Sample Image size by 2 percent.

21. Go to step 2.

### III. RETRIEVE Best Match to Sample Image from Database, Sample Origin Known to be True Stored Image Origin

This time, offsetTheta can be used.

The algorithm is identical, except that offsetTheta is added to the query changing Steps 13 and 15:

```
      13. theta = 1000*atan2(Y, X).
          TileData = new Collection( ).
          TileData.addAll( tileID, X, Y, theta, mean, stddev,
            centroidX, centroidY, colorIndex);
15. ...
      WHERE( tileId = ?)
            and ((offsetX>=?) and (offsetY>=?)
            and (offsetTheta>=?) and (offsetTheta<=?)
      ...
      Parameters = ( tileID, X/2, Y/2, theta−50, theta+50,
                  mean*0.9, mean*1.1, stddev*0.9, stddev*1.1,
                  centroidX*0.9, centroidX*1.1,
                  centroidY*0.9, centroidY*1.1,
                  colorIndex );
```

What follows are the database table descriptions of our example embodiment. The syntax below is suitable for a MySQL database server, but similar table definitions will work for other vendors. The Offsets table holds all the tile data. Our embodiment uses a covering index, so that all the necessary fields can be found within the index itself. Thus, once a tile row is located in the index, there is no need to fetch its imageID from the Offsets table. This enhances recall speed.

```
CREATE TABLE ‘Offsets‘ (
  ‘tileID‘ bigint(20) DEFAULT NULL,
  ‘imageID‘ int(11) DEFAULT NULL,
  ‘offsetX‘ smallint(6) DEFAULT NULL,
  ‘offsetY‘ smallint(6) DEFAULT NULL,
  ‘tileMean‘ smallint(5) unsigned DEFAULT NULL,
  ‘tileSigma‘ smallint(5) unsigned DEFAULT NULL,
  ‘centroidX‘ smallint(5) unsigned DEFAULT NULL,
  ‘centroidY‘ smallint(5) unsigned DEFAULT NULL,
  ‘offsetTheta‘ smallint(5) unsigned DEFAULT NULL,
  ‘colorIndex‘ tinyint(3) unsigned DEFAULT NULL,
  KEY ‘Idx_Offsets‘
(‘tileID‘,‘tileMean‘,‘tileSigma‘,‘centroidX‘,‘centroidY‘,‘offsetX‘,
‘offsetY‘,‘offsetTheta‘,‘colorIndex‘,‘imageID‘)
) ENGINE=MyISAM DEFAULT CHARSET=latin1 PACK_KEYS=1
/*!50100 PARTITION BY HASH (tileID div 5)
PARTITIONS 40 */
The fileSources table holds information about the original image file.
CREATE TABLE ‘fileSources‘ (
  ‘id‘ bigint(20) NOT NULL AUTO_INCREMENT,
  ‘pathId‘ bigint(20) DEFAULT NULL,
  ‘filename‘ varchar(250) DEFAULT NULL,
  ‘width‘ int(11) DEFAULT NULL,
  ‘height‘ int(11) DEFAULT NULL,
  ‘dateAndTime‘ datetime DEFAULT NULL,
  PRIMARY KEY (‘id‘),
  UNIQUE KEY ‘unique_filename‘ (‘pathId‘,‘filename‘),
  KEY ‘Idx_FileSources‘ (‘pathId‘,‘filename‘)
) ENGINE=InnoDB AUTO_INCREMENT=14701 DEFAULT
CHARSET=latin1
```

The imageSources table holds information about one image, typically rescaled or rotated. It holds a reference to the original file, of the fileSources table.

```
CREATE TABLE ‘imagesources‘ (
  ‘id‘ bigint(20) NOT NULL AUTO_INCREMENT,
  ‘fileId‘ bigint(20) DEFAULT NULL,
  ‘width‘ int(11) DEFAULT NULL,
  ‘height‘ int(11) DEFAULT NULL,
  ‘shiftX‘ int(11) DEFAULT NULL,
  ‘shiftY‘ int(11) DEFAULT NULL,
  ‘rotation‘ int(11) DEFAULT NULL,
  PRIMARY KEY (‘id‘),
  UNIQUE KEY ‘unique_images‘
(‘fileId‘,‘width‘,‘height‘,‘shiftX‘,‘shiftY‘,‘rotation‘),
  KEY ‘Idx_ImageSources‘ (‘fileId‘)
) ENGINE=InnoDB AUTO_INCREMENT=51895 DEFAULT
CHARSET=latin1
```

The pathSources table holds information about a directory path, for images recorded from disk.

```
CREATE TABLE ‘pathsources‘ (
  ‘id‘bigint(20) NOT NULL AUTO_INCREMENT,
  ‘pathname‘varchar(4096) DEFAULT NULL,
  ‘ip‘ varchar(25) DEFAULT NULL,
  ‘drive‘ varchar(10) DEFAULT NULL,
  ‘volume‘ varchar(256) DEFAULT NULL,
  PRIMARY KEY (‘id‘),
  KEY ‘Idx_PathSources‘ (‘pathname‘(767))
) ENGINE=InnoDB AUTO_INCREMENT=55 DEFAULT
CHARSET=latin1
```

The urlSources table holds information about the URL wherein a web-based image was found and recorded.

```
CREATE TABLE ‘urlsources‘ (
  ‘id‘ bigint(20) NOT NULL AUTO_INCREMENT,
  ‘url‘ varchar(4096) DEFAULT NULL,
  ‘dateAndTime‘ datetime DEFAULT NULL,
  ‘errorString‘ varchar(40) DEFAULT NULL,
  PRIMARY KEY (‘id‘),
  KEY ‘Idx_UrlSources‘ (‘url‘(767))
) ENGINE=InnoDB DEFAULT CHARSET=latin1
```

1. A method for rapid indexing of images based on storing an expression of the individual contents, coordinates and source image identifier of each of a plurality of small, fixed sized, possibly overlapping tiles found in an image, said method possibly being re-applied to a series of reduced and possibly rotated versions of each indexed image.

2. The method of claim 1 where the individual members of said plurality of tiles are selected or rejected based on some measure of the tiles' contents and its location in the image.

3. The method of claim 2, where the measure used corresponds in some way to the tile's information content, such as its entropy, variance, geometric center, or a combination of such measures, whereby the tile may be selected if that measure exceeds some threshold value.

4. The method of claims 1, 2 and 3 wherein when indexing an image for storage, a regular grid is imposed on the image, with the restriction that fewer than some number of tiles be extracted (possibly overlapping other tiles) from each such grid element, for indexing, based on the measure described in claim 2; in the case of a tie, the tile with the uppermost, then leftmost coordinates wins.

5. The method of claim 1 wherein the expression of each tile consists in generating a binary representation of its contents, performed by a threshold operation based on the tile's average value or its median value; the tile's centroid location; the tile's average brightness; its brightness variance; its polar coordinates from the image upper left corner; its average color or its brightest color value.

6. A method for retrieving a stored image identifier from a query image based on first extracting a plurality of tiles from the query image; collecting matching tiles from the database; sorting the results by candidate image id; for each candidate stored image, calculating the average and standard deviation of the difference between the stored tile offsets and the corresponding tile offsets collected from the query image; selecting the best matching candidate stored image, or none if there is no such match; and if there is no such match, resizing and/or rotating the query image and repeating the search.

7. The method of claims 1 and 6, used in conjunction with a means for acquiring and submitting a query image for identification.

8. The method of claim 1 used in conjunction with a means for acquiring images for indexing, such as a web-crawler or robotic camera.
